(19) United States
(12) Patent Application Publication
(10) Pub. No.: US 2020/0125500 A1
(43) Pub. Date: Apr. 23, 2020

(54) VIRTUALIZATION METHOD FOR DEVICE MEMORY MANAGEMENT UNIT

(71) Applicant: SHANGHAI JIAO TONG UNIVERSITY, Shanghai (CN)

(72) Inventors: Haibing GUAN, Shanghai (CN); Yu XU, Shanghai (CN); Yaozu DONG, Shanghai (CN); Jianguo YAO, Shanghai (CN)

(21) Appl. No.: 16/606,689

(22) PCT Filed: Sep. 15, 2017
(86) PCT No.: PCT/CN2017/101807

§ 371 Date: Oct. 18, 2019

(30) Foreign Application Priority Data
Apr. 18, 2017 (CN) 201710255246. 7

(51) Int. Cl. G06F 12/1036; G06F 12/1009; G06F 12/06; G06F 12/0873

(52) U.S. Cl. CPC G06F 12/1036; G06F 12/1009; G06F 2212/7201; G06F 12/0873; G06F 12/0669

(57) ABSTRACT

The present disclosure provides a virtualization method for a device MMU, including: multiplexing a client MMU as a first layer address translation: a client device page table translates a device virtual address into a client physical address; using IOMMU to construct a second layer address translation: IOMMU translates the client physical address into a host physical address through a TO page table of a corresponding device in IOMMU. The virtualization method for a device MMU proposed by the present disclosure can efficiently virtualize the device MMU; successfully combines IOMMU into Mediated Pass-Through, and uses the system IOMMU to perform the second layer address translation, such that the complicated and inefficient Shadow Page Table is abandoned; not only improves the performance of the device MMU under virtualization, but also is simple to implement and completely transparent to the client, and is a universal and efficient solution.

### CROSS-REFERENCE TO RELATED APPLICATIONS

This application is a national stage application of PCT Application No. PCT/CN2017/101807. This Application claims priority from PCT Application No. PCT/CN2017/101807, filed Sep. 15, 2017 and CN Application No. 201710255246. 7, filed Apr. 18, 2017, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### TECHNICAL FIELD

The present disclosure relates to the field of memory management unit (MMU) technologies, and in particular to a virtualization method for a device MMU.

### BACKGROUND

Memory Management Unit (MMU) is capable of efficiently performing virtual memory management, and some modern devices also utilize MMU for address translation within the device. Typical devices with MMU are graphics processing unit (GPU), image processing unit (IPU), Infiniband, and even Field Programmable Gata Array (FPGA). However, there is not a satisfactory solution currently to support the virtualization of the device MMU. In the current mainstream IO (Input/output) virtualization solution, Device Emulation and Para-Virtualization use CPU to simulate device address translation. This method is very complicated and has low performance and is difficult to support all functions of the emulated device; Direct Pass-Through introduces the hardware IOMMU (Input/output Memory Management Unit), which sacrifices the sharing ability of the device to dedicate the device to a single client, thus to implement all functions and optimal performance of the device; the Single Root I/O Virtualization (SR-IOV) technology creates multiple PCIe functions and assigns them to multiple clients, thus enable device address translation for multiple clients simultaneously. However, SR-IOV is complex in hardware and is limited by line resources, and the scalability is affected.

A Mediated Pass-Through technology has recently emerged as a product-level GPU full virtualization employed by gVirt. The core of Mediated Pass-Through is to pass through the critical resources related to the performance, capture and simulate the privileged resource. Mediated Pass-Through employs Shadow Page Table to virtualize the device MMU. However, the implementation of Shadow Page Table is complex and results in severe performance degradation in memory-intensive tasks. Taking gVirt as an example, although gVirt performs well in normal tasks, for memory-intensive image processing tasks, the performance decreases by 90% in the worst case. Due to the access of Hypervisor, the maintenance of the Shadow Page Table is very expensive. In addition, the implementation of Shadow Page Table is quite complex, gVirt contains about 3500 lines of code to virtualize the GPU MMU, such a large amount of code is difficult to maintain and easily lead to potential program errors. Furthermore, the Shadow Page Table requires the client driver to explicitly inform the Hypervisor of the release of the client page table, such that the Hypervisor can correctly remove the write protection of the corresponding page. Modifying the client driver is acceptable, but when the release of the client page table is in the charge of the client kernel (OS), it is not appropriate to modify the kernel to support the device MMU virtualization.

No descriptions or reports of similar techniques to the present disclosure have been found, and similar data at home and abroad have not yet been collected.

### SUMMARY

In view of the above-mentioned deficiencies in the prior art, the present disclosure is directed to propose an efficient virtualization solution for a device MMU, that is, a virtualization method for a device MMU, to replace the Shadow Page Table implementation in Mediated Pass-Through.

The present disclosure is implemented by the following technical solutions.

A virtualization method for a device memory management unit MMU, comprising:

multiplexing a client MMU as a first layer address translation: a client device page table translates a device virtual address into a client physical address;

using an input/output memory management unit IOMMU to construct a second layer address translation: the IOMMU translates the client physical address into a host physical address through an input/output page (I/O) table of a corresponding device in the IOMMU; when the device owner is switched, the second layer address translation is dynamically switched accordingly;

causing, by decentralizing address spaces of various engines in the device, the address spaces of the various engines in the device not to overlap with each other, and in turn, causing the IOMMU to simultaneously remap device addresses of multiple clients.

Preferably, the second layer address translation is transparent to a client.

Preferably, the client physical address output by the first layer address translation is allowed to exceed an actual physical space size.

Preferably, the IO page table of the corresponding device in the IOMMU is multiplexed by employing a time division strategy; specifically, the time division strategy comprises:

when a client is started up, constructing an input/output page table candidate for the client, the IO page table candidate is the mapping of the client physical address to the host physical address; and when the device is assigned to a privileged client, dynamically switching the IO page table corresponding to the privileged client in the input/output page table candidate.

Preferably, in the process of dynamically switching, only a root pointer in a context entry of IOMMU remapping component needs to be replaced.

Preferably, the decentralizing address spaces of various engines in the device is implemented by:

expanding or limiting the address space of various engines by turning on or off one or more bits of each engine IO page table entry within the device.

Preferably, when multiplexing the client IO page table by employing a time division strategy, the method further comprising:

refreshing an Input/output Translation Lookaside Buffer (IOTLB) of the device by employing Page-Selective-within-Domain Invalidation strategy; and

Page-Selective-within-Domain Invalidation strategy refers to:

assigning a special Domain Id to the device, wherein, only IOTLB entry in the memory space covered by all clients in Domain Id is refreshed.

Compared with the prior art, the present disclosure has the following beneficial effects:

1. The virtualization method for a device MMU proposed by the present disclosure can efficiently virtualize the device MMU.

2. The virtualization method for a device MMU proposed by the present disclosure successfully combines IOMMU into Mediated Pass-Through, and uses the system IOMMU to perform the second layer address translation, such that the complicated and inefficient Shadow Page Table is abandoned.

3. The virtualization method for a device MMU proposed by the present disclosure not only improves the performance of the device MMU under virtualization, but also is simple to implement and completely transparent to the client, and is a universal and efficient solution.

### BRIEF DESCRIPTION OF THE DRAWINGS

Other features, objects, and advantages of the present disclosure will become apparent from the detailed description of a non-limiting embodiment with reference to the accompanying drawings.

The accompanying drawings illustrate one or more embodiments of the present disclosure and, together with the written description, serve to explain the principles of the invention. Wherever possible, the same reference numbers are used throughout the drawings to refer to the same or like elements of an embodiment.

FIG. 1 is a schematic diagram of a time division multiplexed IO page table;

FIG. 2 is a schematic diagram of an overall architecture of gDemon;

FIG. 3 is a schematic diagram of GGTT offset and remapping;

FIG. 4 is a schematic diagram of GMedia benchmark test results;

FIG. 5 is a schematic diagram of Linux 2D/3D benchmark test results; and

FIG. 6 is a schematic diagram of Windows 2D/3D benchmark test results.

### DETAILED DESCRIPTION

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It is appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present disclosure.

It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It are also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It is understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present disclosure belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

Embodiments of the invention are illustrated in detail hereinafter with reference to accompanying drawings. It should be understood that specific embodiments described herein are merely intended to explain the invention, but not intended to limit the invention.

An embodiment of the present disclosure will be described in detail below. The present embodiment is implemented on the premise of the technical solution of the present disclosure, and detailed implementation manners and specific operation procedures are set forth herein. It should be noted that a number of variations and modifications may be made by those skilled in the art without departing from the spirit and scope of the invention and they all fall within the scope of the present disclosure.

### Embodiment

The virtualization method for a device MMU proposed in the present embodiment is referred to as Demon (Device Mmu Virtualization). The main idea of Demon is to multiplex the client MMU as a first layer address translation and use IOMMU to construct a second layer address translation. When the device owner is switched, Demon dynamically switches the second layer address translation. To better support fine-grained parallelism within a device with multiple engines, Demon proposed a hardware proposal such that the address spaces of various engines within the device do not overlap with each other, and in turn, the IOMMU can simultaneously remap the device addresses of multiple clients. In Demon, a device virtual address is first translated into a guest physical address by the client device page table, and then translated by IOMMU into the host physical address through the corresponding IO page table. Here, the second layer address translation is transparent to the client, this feature makes Demon to become a universal solution. Next, the details of Demon's design are described in detail.

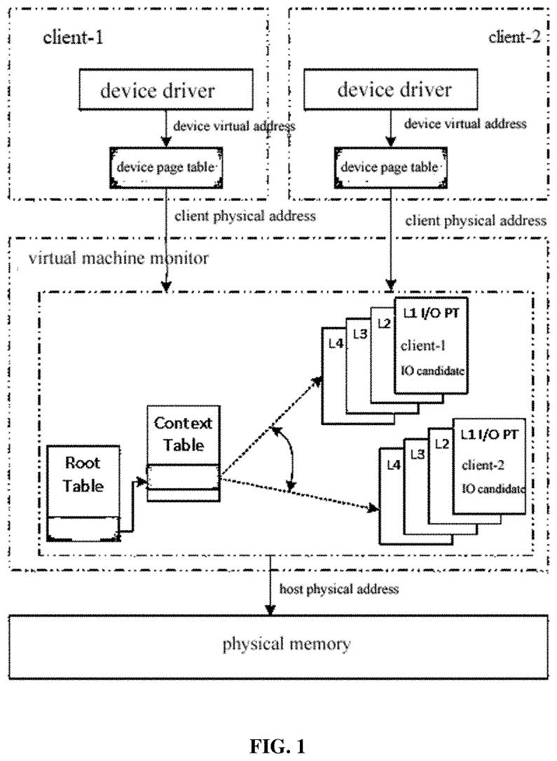

The dynamic switching of IO page table is firstly described. As is known to us, all DMA requests initiated from the same device can only be remapped by a uniquely determined IO page table, which is determined by the BDF number of the device, so one IO page table can only service one Client. In order to solve the IOMMU sharing problem, Demon employs a time division strategy to multiplex the IO page table of the corresponding device in the IOMMU, as shown in FIG. 1. When a client is started up, Demon constructs an IO page table candidate for the client. The IO page table candidate is the mapping of the client physical address to the host physical address (Physical-to-Machine Mapping, P2M). Demon assigns the device to a privileged client (Dom0), and the IO page table corresponding to the privileged client is dynamically switched among the individual IO page table candidates. To complete the switching process, only the root pointer (L4 page table root address) in the context entry of the IOMMU remapping component needs to be replaced; in fact, since the client's physical memory is generally not too large, only several page table entries in the level 3 page table need to be replaced.

The division of the IO page table is then described. The time division multiplexing of the IO page table solves the IOMMU sharing problem, but at the same time, only one client can handle the task, because the IO page table at this time fills the IO page table candidate corresponding to the client. For a complex device with multiple independent working engines, tasks from each client may be assigned to each engine simultaneously, and is speed up by using parallelism. To solve the problem of fine-grained parallelism, Demon proposed a hardware proposal to decentralize the address spaces of various engines in the device. There are many ways to eliminate address space overlap between various engines, for example, the address space of each engine is expanded/limited by opening/closing one or more bits of each engine page table entry. Here, the output of the first layer of translation can exceed the actual physical space size, because the second layer of translation will be remapped to the correct machine physical address. For example, if 33 bits reserved by the page table entry are put forward, the original GPA will become GPA+4G, which will never overlap with the original [0, 4G] space; on the other hand, the mapping in the original IO page table (GPA, HPA) now becomes (GPA+4G, HPA) to complete the correct address remapping. The division of the IO page table enables device address translation for multiple clients as long as the address spaces of the engines being used by the client do not overlap each other.

The efficient IOTLB (Input/output Translation Lookaside Buffer) refresh strategy is finally described. In IOMMU, valid translations are cached in IOTLB to reduce the overhead of IO page tables when translating. However, in Demon, due to the time division multiplexing strategy, IOTLB must be refreshed in order to eliminate dirty translation cache. Here, the refresh of the IOTLB will inevitably lead to a decline in performance. To reduce the overhead of IOTLB refresh, Demon employs Page-Selective-within-Domain Invalidation strategy. Under this strategy, Demon assigns a special Domain Id to the (virtualized) device, and only the IOTLB entry in the memory space covered by all clients in the domain of Domain Id is refreshed instead of globally refreshed. By reducing the range of IOTLB refresh, the overhead of IOTLB refresh is minimized.

To make the purpose, technical solution and advantages of the present embodiment clearer, the present embodiment will be described in detail below in conjunction with an example of GPU MMU virtualization.

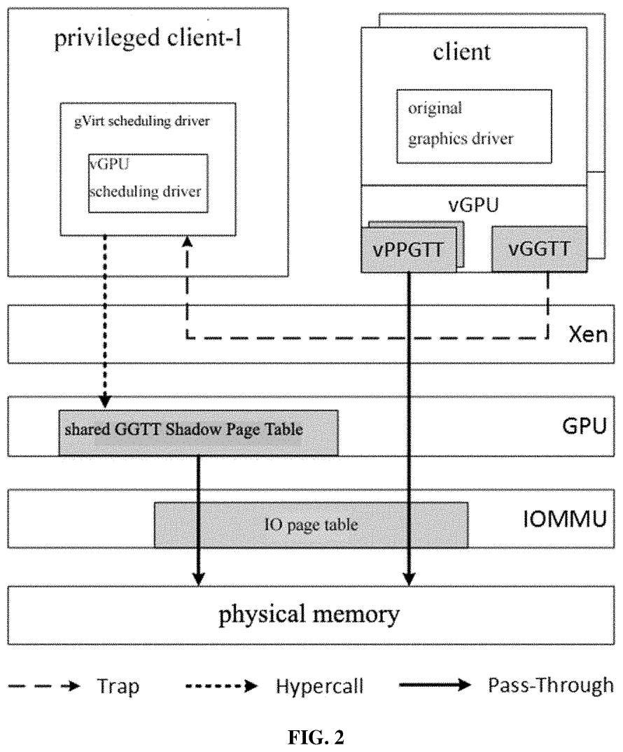

The GPU MMU has two-page tables, that is, a Global Graphics Conversion Table (GGTT) and a Per-Process Graphics Conversion Table (PPGTT). gVirt virtualizes the GPU MMU by means of Shadow Page Table, and the architecture gDemon obtained by virtualizing the GPU MMU by using the Demon technology provided in this embodiment is shown in FIG. 2.

It is relatively straightforward to apply Demon to GPU MMU virtualization. On our test platform, the GPU's BDF number is 00:02.0, and the IO page table it determines requires time division multiplexing. Specifically, when scheduling a virtual GPU device, gDemon will inserts an additional Hypercall to explicitly inform the Hypervisor to switch the IO page table to the corresponding candidate. PPGTT is located in the memory and is unique to each client, so PPGTT can be passed through in gDemon. However, GGTT needs further adjustment because of its unique nature.

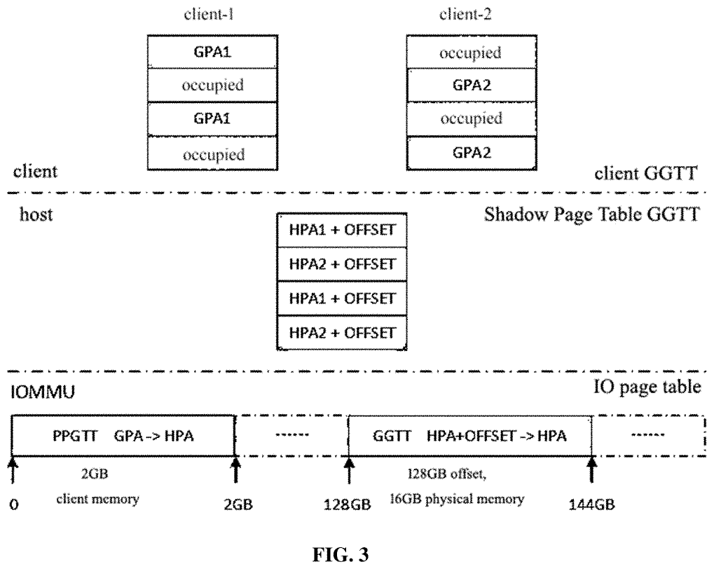

The GGTT is located in the MMIO area and is a privileged resource. Due to the separate CPU and GPU scheduling strategies, the GGTT needs to be split; meanwhile, Ballooning technology is also employed to significantly improve the performance. For these reasons, GGTT can only be virtualized with Shadow Page Table. In the gDemon environment, to integrate the GGTT Shadow Page Table implementation, a large offset needs to be added to the GGTT Shadow Page Table entry, such that it does not overlap with the PPGTT address space, and the IO page table also needs a corresponding remapping, as shown in FIG. 3 (assuming a client memory of 2 GB and a GGTT offset of 128 GB).

The test platform selects the 5th generation CPU, i5-5300U, 4 core, 16 GB memory, Intel HD Graphics 5500 (Broadwell GT2) graphics card, 4 GB video memory, 1 GB of which is AGP Aperture. The client selects 64-bit Ubuntu 14.04 and 64-bit Window 7. The host runs a 64-bit Ubuntu 14.04 system, and Xen 4.6 is the Hypervisor. All clients are assigned 2 virtual CPUs, 2 GB of RAM and 512 MB of video memory (128 MB of which is AGP Aperture). GMedia, Cario-perf-trace, Phoronix Test Suite, PassMark, 3DMark, Heaven, and Tropics are selected for Benchmark test.

Firstly, the simplicity of gDemon's architecture is tested by virtualizing the module code size. The code used to virtualize the GPU MMU in gVirt totals 3,500 lines, wherein, 1200 lines are for the GGTT sub-module, 1800 lines are for the PPGTT sub-module, and 500 lines are for the address translation auxiliary module. In gDemon, the GGTT sub-module has 1250 lines, the PPGTT sub-module's Shadow Page Table is completely eliminated, and 450 lines of code of the IO page table maintenance module is added, so there are a total of 2200 lines of code, 37% less code amount than gVirt.

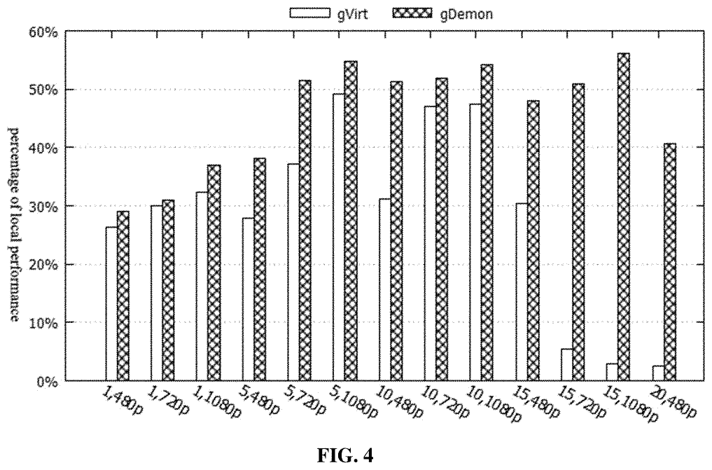

Then in the GMedia benchmark test, due to the large amount of memory usage, the client page table operation is frequent, and the requirement on GPU MMU virtualization is high, so the GMedia can well reflect the performance of gVirt and gDemon. The test results are shown in FIG. 4. GMedia has two parameters, that is, channel number and resolution. The larger the parameter, the higher the load of GMedia. As can be seen from FIG. 4, the performance of gDemon is as high as 19.73 times that of gVirt under the test case with 15 channels and 1080p resolution.

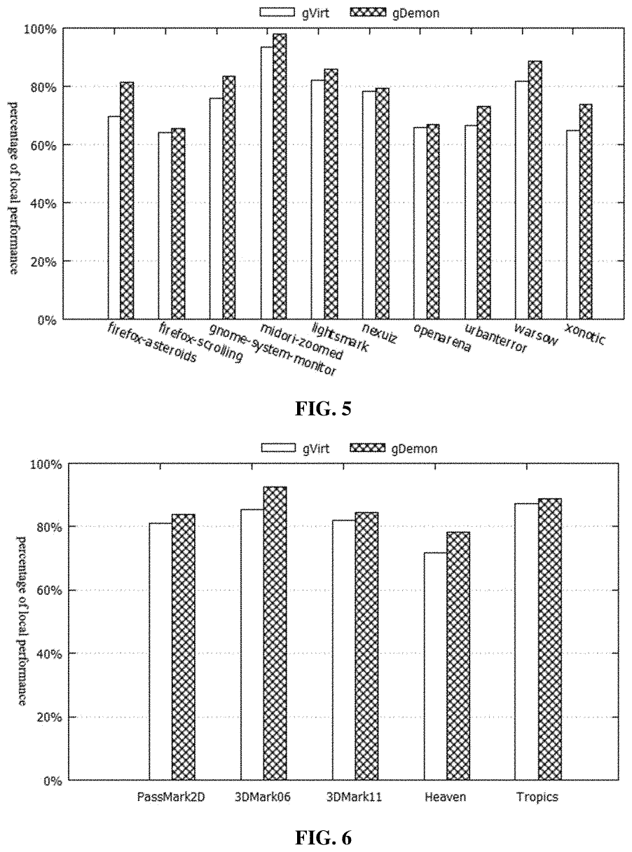

Finally, in the general 2D/3D tasks, the client page table operation is relatively less, and the GPU MMU virtualization is not the main performance bottleneck. However, the performance of gDemon is superior to the performance of gVirt in almost all test cases, and the performance increases by up to 17.09% (2D) and 13.73% (3D), as shown in FIGS. 5 and 6.

It indicates through the implementation and test of the GPU MMU virtualization that Demon is an efficient solution for device MMU virtualization.

The specific embodiment of the present disclosure has been described above. It will be understood that the present disclosure is not limited to the specific embodiment described above, and various modifications and changes may be made by those skilled in the art without affecting the substance of the present disclosure.

The foregoing description of the exemplary embodiments of the present disclosure has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A virtualization method for a device Memory Management Unit (MMU), comprising:
multiplexing a client MMU as a first layer address translation: a client device page table translates a device virtual address into a client physical address;
using an input/output memory management unit IOMMU to construct a second layer address translation: the IOMMU translates the client physical address into a host physical address through an input/output (IO) page table of a corresponding device in the IOMMU; when the device owner is switched, the second layer address translation is dynamically switched accordingly; and
causing, by decentralizing address spaces of various engines in the device, the address spaces of the various engines in the device not to overlap with each other, and in turn, causing the IOMMU to simultaneously remap device addresses of multiple clients.

2. The virtualization method for a device MMU according to claim 1, wherein the second layer address translation is transparent to a client.

3. The virtualization method for a device MMU according to claim 1, wherein the client physical address output by the first layer address translation is allowed to exceed an actual physical space size.

4. The virtualization method for a device MMU according to claim 1, wherein the input/output page table of the corresponding device in the IOMMU is multiplexed by employing a time division strategy; specifically, the time division strategy comprises:
when a client is started up, constructing an input/output page table candidate for the client, the input/output page table candidate is the mapping of the client physical address to the host physical address; and when the device is assigned to a privileged client, dynamically switching the input/output page table corresponding to the privileged client in the input/output page table candidate.

5. The virtualization method for a device MMU according to claim 4, wherein in the process of dynamically switching only a root pointer in a context entry of IOMMU remapping component needs to be replaced.

6. The virtualization method for a device MMU according to claim 1, wherein the decentralizing address spaces of various engines in the device is implemented by:
expanding or limiting the address space of various engines by turning on or off one or more bits of each engine input/output page table entry within the device.

7. The virtualization method for a device MMU according to claim 4, further comprising:
refreshing an Input/output Translation Lookaside Buffer (IOTLB) of the device by employing Page-Selective-within-Domain Invalidation strategy; and
page-Selective-within-Domain Invalidation strategy refers to:
assigning a special Domain Id to the device, wherein, only IOTLB entry in the memory space covered by all clients in Domain Id is refreshed.
